(19) United States
(12) Patent Application Publication
(10) Pub. No.: US 2022/0340362 A1
(43) Pub. Date: Oct. 27, 2022

(54) A STORAGE SYSTEM

(71) Applicant: Espen WATHNE, Mandal (NO)

(72) Inventor: Espen WATHNE, Mandal (NO)

(21) Appl. No.: 17/763,192

(22) PCT Filed: Sep. 24, 2020
(86) PCT No.: PCT/NO2020/050242

§ 371 Date: Mar. 23, 2022

(30) Foreign Application Priority Data
Sep. 27, 2019 (NO) 20191165

(51) Int. Cl. B65G 1/10; A47B 45/00

(52) U.S. Cl. CPC B65G 1/10; A47B 45/00

(57) ABSTRACT

It is described a storage system with a number of storage racks that can be moved sideways, on rails (4) in the floor. The racks are mounted on support frames (1). Each support frame (1) is rectangular with at least two first support elements (7) lying along a first rail (4) and are telescopically connected by connecting tubes (8), and at least two other support elements (7) lying along a second rail (4) and are telescopically connected by connecting tubes (8), wherein the support elements (7) are further connected by telescopic shelf tubes (16) extending across the rails (4), and each storage shelf consists of vertical wall tubes (15) connected together by horizontal wall coupling tubes (18) and horizontal telescopic shelf tubes (16), the wall tubes (15), the wall coupling tubes (18) and the shelf tubes (16) being connected to tube holders (17a-c) which can be mounted in an optional position along the vertical wall tubes (15) and where the distance between the wall tubes (15) can be telescopically adjusted.

### FIELD OF THE INVENTION

The present application relates to a system for storing objects.

### BACKGROUND

Storage systems come in a number of variants. For storage of smaller objects, such as books, there is a compact shelving system where mobile storage racks with shelves roll on rails in the floor (Compactus system). The racks can be pushed tightly together, with only one opening where material may be loaded or retrieved. The racks can be moved along the rails by turning a hand wheel, or by operating an electric motor, so that all shelves are accessible as desired. Such solutions are also used in other industries, for example for storing tires or car parts. Since there is only a single “space” between the racks, such a system provides a greater storage density than free-standing racks and therefore a better utilization of the premises. Because of the rails, the system depends on an accurate flat and levelled floor. This is not always the case, for example in an external warehouse. Furthermore, the system is exposed to dust and particles falling into the rails/grooves so that the shelves may run slowly or become wedged.

Large displaceable shelving systems are known in which each rack is equipped with a frame-shaped base. In each base there is an electric motor that moves the rack when needed. To ensure safety, light barrier detectors have been installed between each rack. This is an expensive solution since each rack is fully equipped with a propulsion system and electronic control system. Furthermore, the rack builds a lot, i.e. it requires a relatively large proportion of the height in rooms with limited ceiling height.

Such storage systems are often installed in premises that have previously been used for another purpose, or an older warehouse where there is a need to increase storage capacity by storing more tightly. The storage systems must therefore be adapted to the dimensions of the existing room in that the individual components must be cut before the storage system is assembled. The storage systems consist of many components, which means that such “tailoring” becomes very extensive.

There is therefore a need for a storage system that is modular so that it can be expanded according to need and available space, is durable and can be installed in buildings with an even or uneven floor surface.

Various storage solutions are known from the patent literature, as described in U.S. Pat. No. 3,080,204 A, JP H01176709 A, U.S. Pat. No. 6,669,314 B1, JP S57104932 U, and U.S. Pat. No. 3,877,593 A.

From U.S. Pat. No. 3,737,047 A a storage system is known with a number of storage racks which can be displaced laterally, the system comprising, among other, a rail which is fastened to a floor, where a number of rectangular support frames are arranged in succession on the rail or floor and where each support frame comprises a wheel which rests against the rail or floor. A storage rack is mounted on each support frame, and each storage rack consists of vertical wall tubes where the support frames and shelves are connected together by horizontal wall connection pipes and horizontal shelf tubes.

### SUMMARY OF THE INVENTION

It is an object of the invention to provide a storage system which satisfies at least some of the above-mentioned needs.

This is achieved with a storage system as defined in the appended claims.

The storage system is made up of telescopic elements so that it can be easily set up according to the customers' wishes and needs for achieving maximum area utilization.

### BRIEF DESCRIPTION OF THE DRAWINGS

The invention will now be described in detail with reference to the accompanying drawings, in which:

FIG. 1a-c show an embodiment of a storage system according to the invention seen from the side, from the front, and in perspective,

FIG. 2a-c show two embodiments of the storage system, intended for storage of car tires,

FIG. 3 is a side view of the inventive the storage system,

FIG. 4a, b show details of the interconnection of the elements in the storage system,

FIGS. 5a, b show a mechanical system for connecting storage racks to each other,

FIGS. 5c, d show a corresponding magnetic system for connecting storage racks to each other,

FIG. 6 shows how the rails carrying the system are arranged.

### DETAILED DESCRIPTION

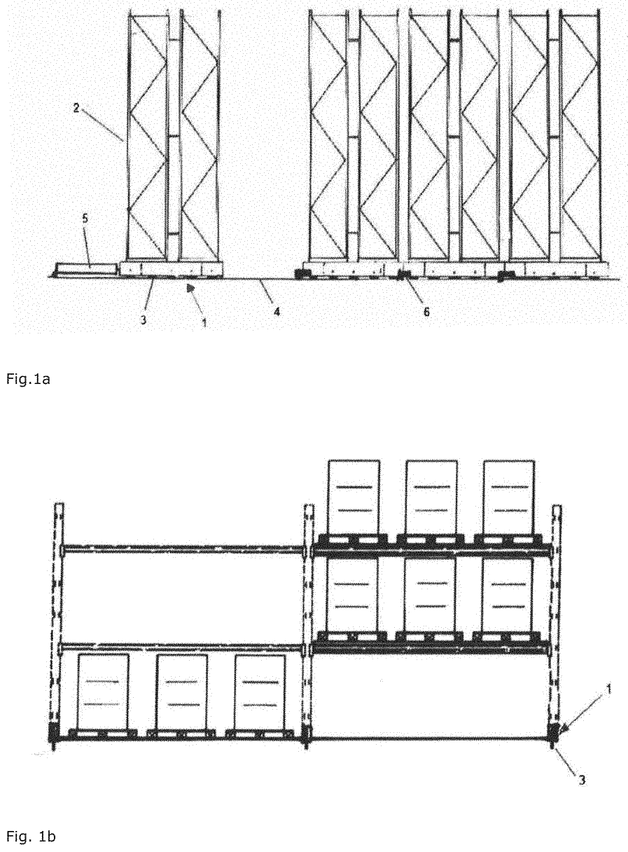

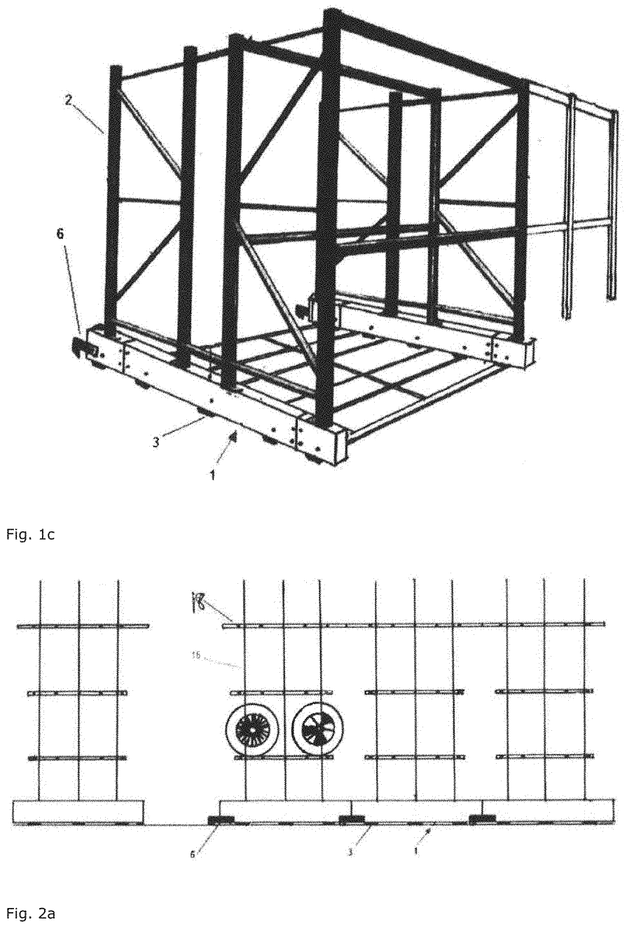

FIGS. 1a-c show an embodiment of a storage system according to the invention, intended for storing heavier objects. The system consists of a number of universal bottom frames 1, each of which carries a storage rack 2, here in the form of a so-called pallet rack. The bottom frames are equipped with wheels 3 and can roll back and forth along rails 4 in the floor. To drive the bottom frames with the racks sideways, a drive unit 5 is mounted, here in the form of a pneumatic cylinder with remote control. The bottom frames are equipped with locking hooks 6 which can connect several racks together so that they move as a unit. When releasing the locking hooks, the racks can be moved individually.

The system thus consists of individual storage racks that are mounted on separate bottom frames. Each rack is a three-dimensional structure consisting of walls in the form of vertical wall tubes 15 which are bonded together by horizontal wall coupling tubes 18. The walls are in turn bonded together by horizontal shelf tubes 16. Likewise, each bottom frame consists of supporting elements 7 which are joined together by horizontal shelf tubes 16.

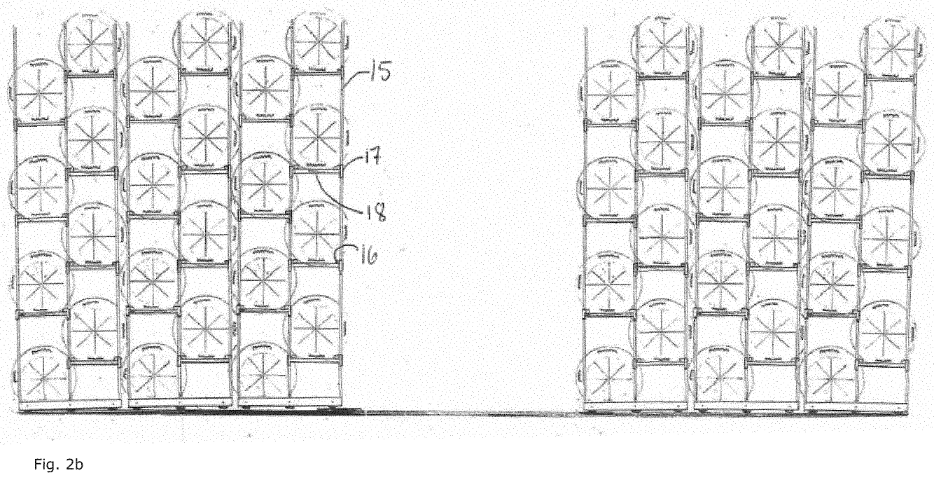

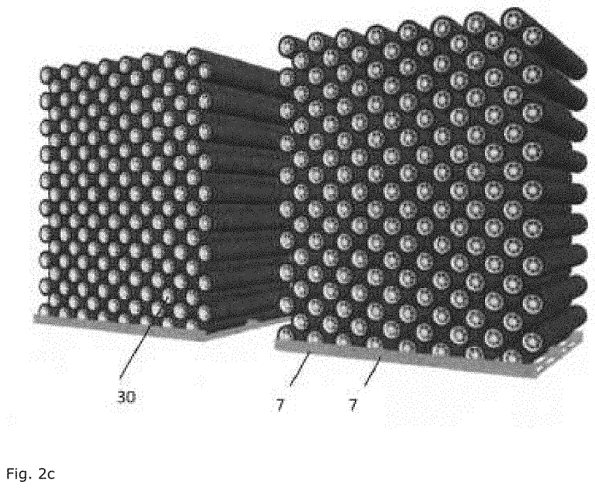

FIG. 2a-c show a version of the storage system which is specially designed for storing car tires. The difference from the previous edition lies in the shelving system. Each storage rack 2 here consists of vertical wall tubes 15 and horizontal shelf tubes 16 which are connected together by tube holders 17. The tube holders are equipped with locking screws which lock the tubes. The position of the tubes is therefore adjustable. FIG. 2a shows the system seen from the side, with two rows of tires placed in one of the shelves. Each shelf is formed by four shelf tubes 16 and each row of tires rests on two shelf tubes. FIG. 2b shows a variant of the system where the shelves carrying the tires are set up in a staggered pattern to achieve a more tightly stacking of the tires reducing voids in the shelves and thereby a better utilization of the available space. This achieves 25% more storage space on a given floor area. FIG. 2c is a perspective view of this system. The shelving system itself has been omitted from the drawing for the sake of clarity. However, the figure shows how tightly the tires can be stored with this system. Several bottom frames are hooked together and pushed to the side so that there is access between the rack rows to store or retrieve tires.

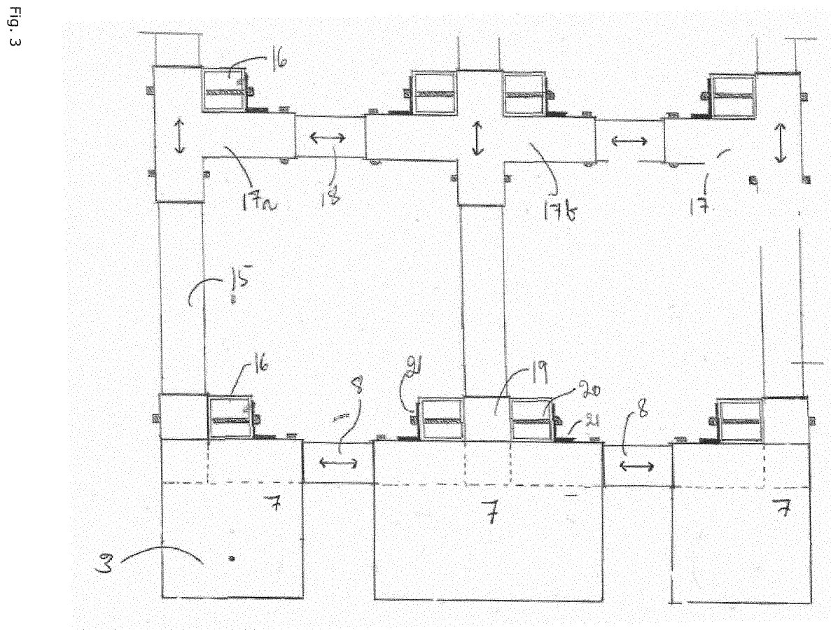

FIG. 3 shows the shelving system in profile. The bottom frame consists of support elements 7 which are held together by longitudinal coupling elements 8. The support elements also form cart-type bases for the racks. In the same way as the racks, the support elements are connected by horizontal shelf tubes 16 to form the bottom frames 1. This is also shown in FIG. 2c, right side, where three support elements in each bottom frame are connected to shelf tubes.

The support elements are telescopically attached to the coupling elements and the dimensions can be adjusted by moving the position of each support element along the coupling elements. The bottom frame can thereby be expanded up to twice the most jointed position of the support elements. Alternatively, several support elements can be joined together directly or with spacers.

The support elements comprise of vertical plinths 19 into which the wall tubes 15 are inserted and fixed with through bolts 20. Tube holders 17a-c are attached to the wall tubes 15 which connect the wall tubes with horizontal wall connection tubes 18. The tube holders can be displaced upwards or downwards along the wall tubes to achieve the desired shelf height and fastened with bolts as shown. Likewise, the distance between the wall tubes 15, which determines the depth of each shelf, can be adjusted with the wall coupling tubes. It is also possible to put the racks together so that a system with offset shelves is obtained as shown in FIG. 2b. The left tube holder element 17a can be assembled with the right tube holder element 17c, which is offset to produce an optimized storage of tires with less empty spaces. More specifically, each shelf comprises first, second and third wall tubes (15), a number of first wall coupling tubes (18) connecting first and second wall tubes (15), a number of second wall coupling tubes (18) connecting second and third wall tubes (15), and wherein the first wall coupling tubes are positioned in the horizontal direction between the corresponding vertical positions of the second wall coupling tubes.

The wall elements (i.e. as shown in FIG. 3) are connected horizontally with telescopic shelf tubes 16. The shelf tubes are mounted by means of brace brackets 21 welded to the tube holders 17, the shelf tube being laid between the tube holders and the bracket 21 and fastened with the bolt 20 which binds the construction together. Correspondingly, plinths 19 are arranged on each support element 7 in which the wall tubes descend. Brace brackets 21 are also attached to the support element so that the shelf tubes can be fastened between the bracket and the plinth 19. An alternative solution is to arrange holes in each tube holder/support element through which the shelf tubes are threaded. The construction shown in the drawing avoids bending forces on the tubes. The construction becomes both stronger and easier to assemble. If necessary, the strength can be further increased by doubling the shelf tubes, i.e. laying several shelf tubes in parallel.

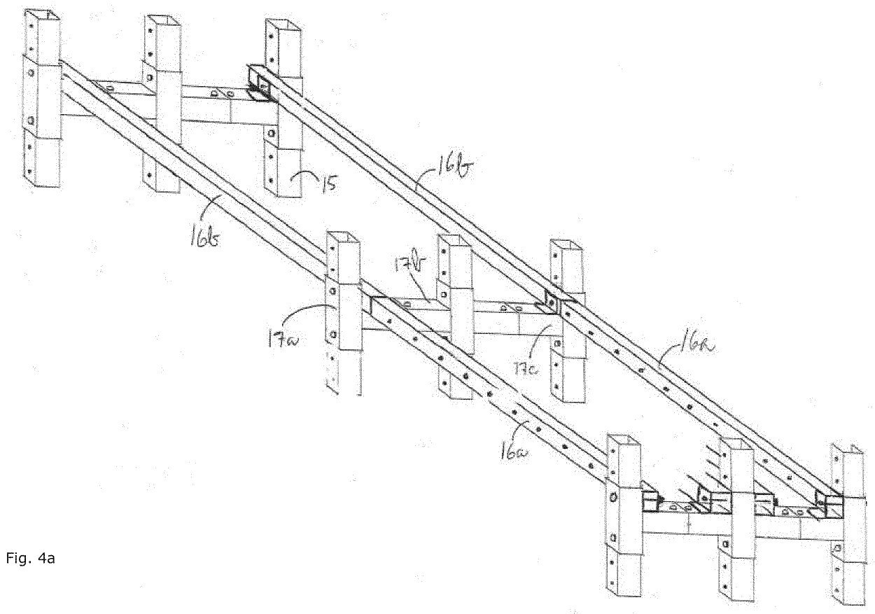

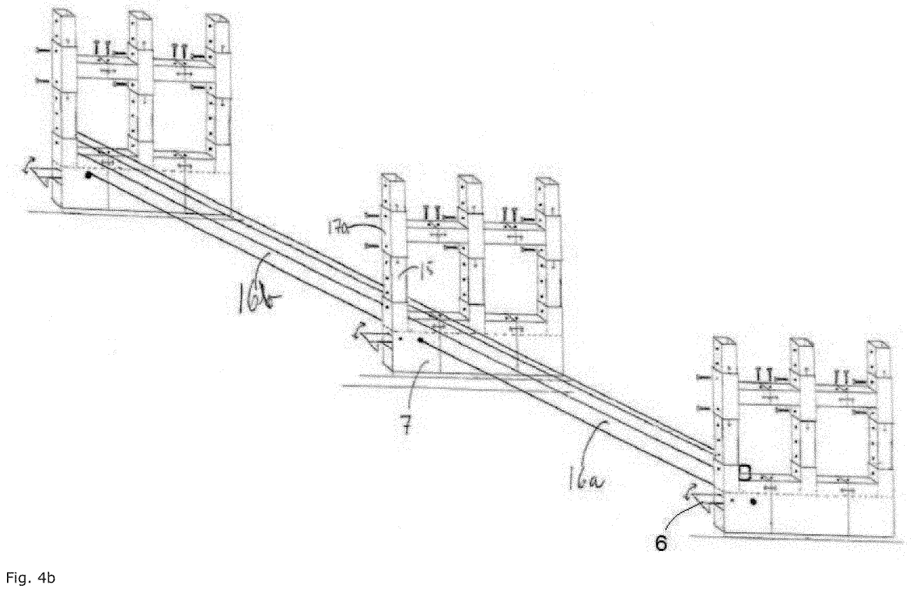

FIG. 4a, b shows how the wall elements are connected to the shelf tubes 16. Each shelf tube consists of a first tube section 16a which can slide telescopically inside a second tube section 16b. The wall elements can then be pushed together until the desired dimension is achieved, whereupon they are bolted together.

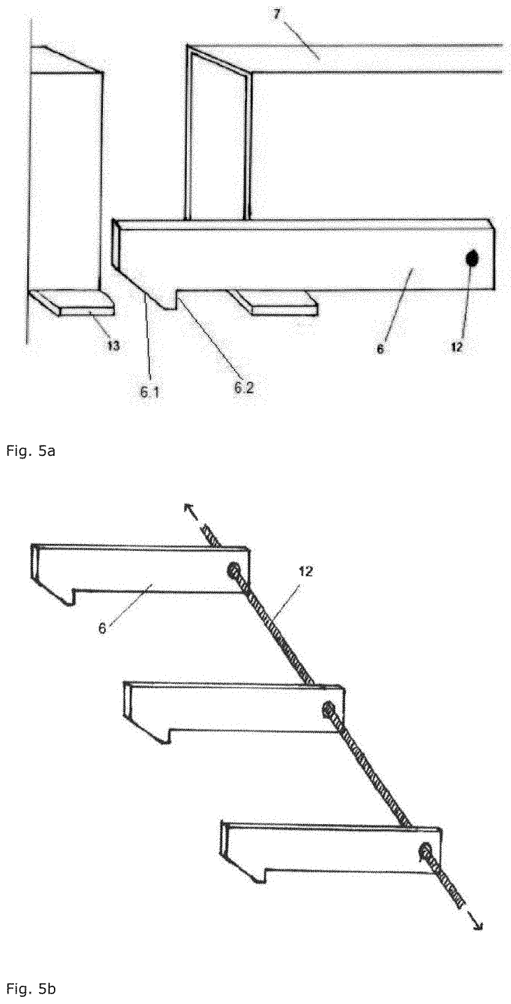

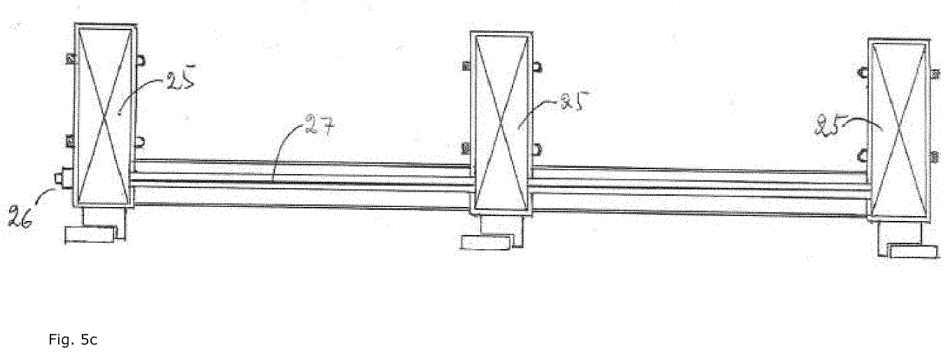

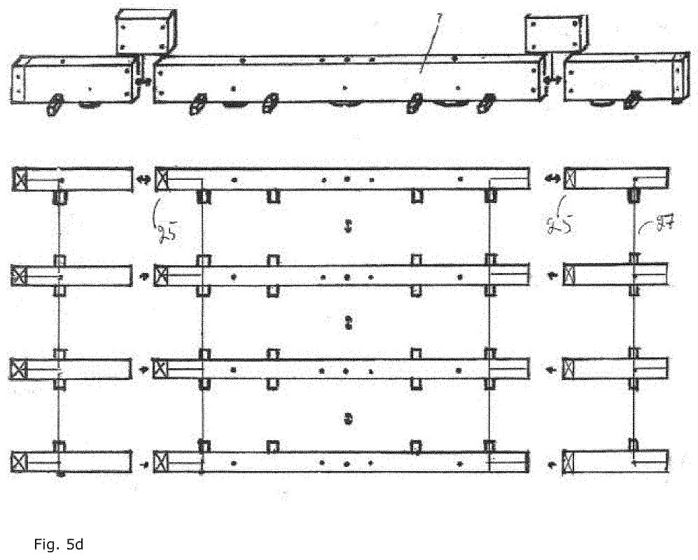

Each support element is also equipped with locking hooks 6, FIG. 5a, b. The support element 7 has a locking hook 6 at one end. The locking hook is arranged to hook into a corresponding locking lug 13 in the corresponding support element in an opposite rack. Each locking hook has a tapered end section 6.1 and a step 6.2. When two racks are brought together, the locking hook of one rack will hit the locking lug of the other rack. Due to the tapered section 6.1 the locking hook will be lifted and climb over the locking lug until the step 6.2 engages the lug and the racks are locked together.

In FIG. 5a the locking hooks and lugs are mounted on the outside of the support elements. In FIG. 4b there is shown an alternative solution wherein the locking hooks are mounted inside the support elements protruding through openings at the end of each support element. The hooks will then engage corresponding openings in the opposite ends of the support elements of the facing racks.

The locking hooks in each rack are connected to a shaft 12 so that it can be maneuvered together. To release the racks the shaft is rotated (by operating a lever, not shown) to lift the hooks from the lugs. An alternative solution is to use magnetic locking of the racks to each other, as shown in FIG. 5c, d, in which an electromagnet 25 is mounted at one end of each support element. The magnets are connected in series (through the cable 27) and the current to the magnets is controlled by a release button 26 on each side of each rack.

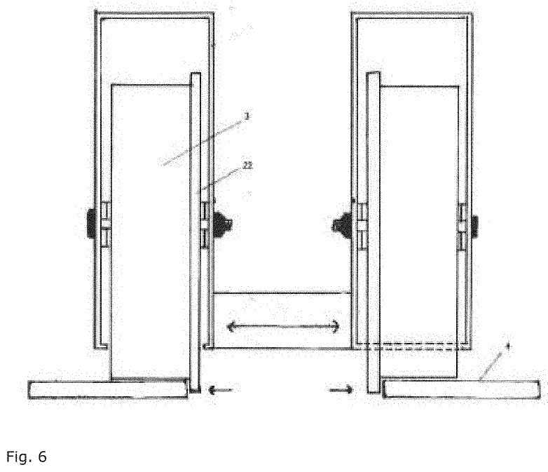

FIG. 6 shows a guide rail 4 with supporting wheels 3. In conventional shelving systems the rails are most often lowered into the floor. This is an expensive solution, especially for retrofitting existing buildings. It can also be a problem when a shelving system is to be installed in an older building with an uneven floor. In this case, the rail consists of a flat steel rail that is mounted lying on the floor. The rail is attached with expansion nails through holes in the rail. The wheel 3 has a flange 22 and rolls along the inside of the rail 4. Even if the rail should run unevenly due to irregularities in the floor, the shelving system will be affected to a small degree and easily pass such irregularities.

The shelves are intended to be moved by means of a pneumatic or hydraulic cylinder mounted in the floor at one end of the rack row.

1. A storage system with storage racks that can be moved sideways, the storage system comprising:
a plurality of rails attached to a floor,
a plurality of support frames arranged in a row on the rails, ones of the support frames comprising wheels that abut against the rails,
a rack mounted on a respective one of the support frames, and
a drive unit to displace the support frames with the storage racks along the rails,
wherein each support frame is rectangular with at least two first support elements lying along a first rail and are telescopically connected by connecting tubes, and at least two other support elements lying along a second rail and are telescopically connected by connecting tubes,
wherein ones of the support elements are further connected by telescopic shelf tubes extending across the rails,
wherein each one of storage shelves includes vertical wall tubes connected together by horizontal wall coupling tubes and horizontal telescopic shelf tubes, and
wherein the wall tubes, the wall coupling tubes and the shelf tubes are connected to tube holders that can be mounted in an optional position along the vertical wall tubes, and where a distance between the wall tubes can be telescopically adjusted.

2. A storage system according to claim 1, wherein each of the storage shelves includes first, second and third wall tubes, and further including:
a plurality of first wall coupling tubes connecting the first and second wall tubes, and
a plurality of second wall coupling tubes connecting the second and third wall tubes,
wherein the first wall coupling tubes are positioned in a horizontal direction between corresponding vertical positions of the second wall coupling tubes.

3. A storage system according to claim 1, wherein at least one of the shelf tubes is fixed in the tube holders between a wall in each tube holder and a brace bracket on the tube holder.

4. A storage system according to claim 1, wherein at least one of the shelf tubes is fixed in the support elements between a base on each support element and a brace bracket on the support element.

5. An apparatus to support storage racks that can be moved laterally, the apparatus comprising:
support frames to be arranged in rows and on rails attached to a floor, ones of the support frames movably coupled to the rails via wheels that abut against the respective rails, ones of the support frames telescopically coupled to one another via connecting tubes that extend between at least two of the rails, ones of the support frames further coupled to one another via telescopic shelf tubes extending across the rails, the storage racks to be mounted on respective ones of the support frames; and
vertical wall tubes to support storage shelves, the vertical wall tubes to extend from the respective support frames and to be coupled together via horizontal wall coupling tubes and horizontal telescopic shelf tubes, wherein the wall tubes, the wall coupling tubes and the shelf tubes are to be coupled to tube holders.

6. The apparatus of claim 5, further including a drive unit to displace the support frames with the storage racks along the rails.

7. The apparatus of claim 5, wherein the tube holders can be mounted in an optional position along the vertical wall tubes, and wherein a distance between the wall tubes can be telescopically adjusted.

8. The apparatus of claim 5, wherein at least one of the shelf tubes is fixed in the tube holders between a wall in each tube holder and a brace bracket on the tube holder.

9. A storage system according to claim 5, wherein at least one of the shelf tubes is fixed in the support frames between a base on each support frame and a brace bracket on the support frame.

10. The apparatus of claim 5, wherein ones of the storage shelves include respective first, second and third wall tubes, and further including:
a plurality of first wall coupling tubes coupling the first and second wall tubes; and
a plurality of second wall coupling tubes coupling the second and third wall tubes, wherein the first wall coupling tubes are positioned in a horizontal direction between corresponding vertical positions of the second wall coupling tubes.
